(19) United States
(12) Patent Application Publication
(10) Pub. No.: US 2013/0090031 A1
(43) Pub. Date: Apr. 11, 2013

(54) COMPOSITE FILM MATERIAL COMPRISING A RESIN OF FLUORENE CROTONATE, FLUORENE CINNAMATE, FLUORENE ACRYLATE, FLUORENE METHACRYLATE, FLUORENE ALLYLETHER OR A COMBINATION THEREOF

(71) Applicants: Alain Dominique Maurice Sismondi, Cairo Montenotte (SV) (IT); Giuseppe Rocca, Cairo Montenotte (SV) (IT); Alfredo Fenoglio, Cairo Montenotte (SV) (IT); Corrado Balestra, Cairo Montenotte (SV) (IT); Ena Marinelli, Cairo Montenotte (SV) (IT); Gian Paolo Ferraro, Cairo Montenotte (SV) (IT); Ezio Perrone, Cairo Montenotte (SV) (IT); Danilo Ferraro, Cairo Montenotte (SV) (IT); Luca Ceruti, Cairo Montenotte (SV) (IT); Mauro Viviani, Cairo Montenotte (SV) (IT)

(72) Inventors: Alain Dominique Maurice Sismondi, Cairo Montenotte (SV) (IT); Giuseppe Rocca, Cairo Montenotte (SV) (IT); Alfredo Fenoglio, Cairo Montenotte (SV) (IT); Corrado Balestra, Cairo Montenotte (SV) (IT); Ena Marinelli, Cairo Montenotte (SV) (IT); Gian Paolo Ferraro, Cairo Montenotte (SV) (IT); Ezio Perrone, Cairo Montenotte (SV) (IT); Danilo Ferraro, Cairo Montenotte (SV) (IT); Luca Ceruti, Cairo Montenotte (SV) (IT); Mauro Viviani, Cairo Montenotte (SV) (IT)

(73) Assignee: FERRANIA TECHNOLOGIES S.P.A., Cairo Montenotte (SV) (IT)

(21) Appl. No.: 13/639,263

(22) PCT Filed: Mar. 31, 2011
(86) PCT No.: PCT/EP2011/055031

§ 371 Date: Dec. 13, 2012

(30) Foreign Application Priority Data
Apr. 6, 2010 (IT) MI2010A 000573
Apr. 6, 2010 (IT) MI2010A 000574
Apr. 6, 2010 (IT) MI2010A 000575
Apr. 6, 2010 (IT) MI2010A 000577
Apr. 6, 2010 (IT) MI2010A 000578

(51) Int. Cl. C03C 25/28

(52) U.S. Cl. CPC C03C 25/285
USPC 442/146; 526/261; 524/548; 442/173; 442/178; 442/180

(57) ABSTRACT

This invention concerns with a composite film or a layered product having high transparency, excellent resistance to heat and excellent dimensional stability, useful in the manufacturing of electronic display devices, photovoltaic devices, lighting devices, automotive windshields and lights, and safety and armored windows.

### FIELD OF THE INVENTION

This invention relates to a composite film material featuring high transparency, outstanding thermal resistance and excellent dimensional stability.

The composite film according to the present invention can be used as an optical substrate in the manufacturing of electronic display devices photovoltaic devices and lighting devices. Another field of application of the composite material described in this invention is in the replacement of glass in the manufacturing of windshields and lights in automotive applications and in reinforced windows.

### STATE OF THE ART

There is a strong requirement for high performance films in the marketplace concerning with their use as thin flexible supports in electronic and optical applications such as, for example, in thin film photovoltaic cells, substrates for plasma and liquid crystal displays, supports for touch panel displays, supports for LED or OLED displays, optical devices, electronic ink displays or the like, supports for lighting devices or OLED lamps.

The first material used in the assembly of supports for displays in notebook computers, flat screen televisions, mobile telephones or satellite navigation systems was glass.

Nevertheless, the glass sheet substrates are easily breakable and have disadvantages in the high specific weight of the material and in the intrinsic difficulties in forming thin flexible supports.

In replacement of glass, several different plastic materials were considered as they are easier to use in the manufacturing of thin flexible screens.

It is known that the polymers derived from BisPhenol A can be used to make flexible plastic supports. Still these materials have the disadvantage of a low resistance to heat and light. The scarce thermal resistance of plastic materials compared to glass is a limitation in the process of deposition of the various layered materials used in the assembly of the displays, as such processes are performed at high temperature. If the glass transition temperature of the polymer used to make the substrate is low, the resulting plastic support will be permanently deformed during the preparation of the display, with a loss of its functionality.

To overcome this problem, polyesters derived from 9,9′-bis(4-hydroxyphenyl)fluorene were disclosed as starting materials in the realization of heat resistant substrates, since the use of fluorene units allows increasing significantly their thermal resistance.

For example, U.S. Pat. No. 3,546,165 discloses polyesters of 9,9′-bis(4-bis(4-hydroxyphenyl)fluorene, obtained by a reaction of said fluorene derivate with a hydrocarbon, eventually halogenated, having from 4 to 15 atoms of carbon or with phthalic acid.

European patent EP 0 396 418 discloses polyesters obtained by an interfacial polymerization technique using 9,9′-bis(4-hydroxyphenyl)fluorene and a mixture comprising 50% or terephthalic acid and 50% of isophthalic acid. Such polyesters are useful as insulating coatings for electrical conductors, as substrates for thermal printing processes, in the optical filed and in general, as fibers.

The polyesters described in U.S. Pat. No. 3,546,165 and EP 0 396 418 feature high thermal resistance and good transparency. Still, they have limited resistance to organic solvents, such as for example chlorinated solvents (chloroform, methylene chloride, dichloroethane) and cyclic ethers (dioxane, dioxolane, tetrahydrofurane), and can be destroyed by amidic solvents, such as N-MethylPyrrolidone and 2-Pyrrolidone.

Other curable compositions comprising 9,9′-bis(4-hydroxyphenyl)fluorene acrylate and methacrylate were described in the preparation of ophthalmic lenses, for example in patent EP 0 598 562. Such compositions show a high refractive index, thanks to the presence of the fluorene group, and their overall characteristics include good thermal resistance, scratch resistance and impact resistance.

Still, the compositions disclosed in the art comprising said polyesters of 9,9′-bis(4-hydroxyphenyl)fluorene do not exhibit a coefficient of linear expansion suitable for their use in substrates for display devices, especially in the production of active matrix display devices, requiring high thermal resistance end low coefficient of linear expansion. The coefficient of linear expansion provides the dimensional variation of the plastic substrate as a function of the temperature of use. Such a deformation is mainly reversible, but the misalignment among the components of the display devices during the various manufacturing steps performed at variable temperatures.

Composite materials incorporating inorganic fillers in curable binders were disclosed in order to reduce the coefficient of linear expansion, such fillers include particles or fibers (for example glass fibers and/or ceramic fibers). Nevertheless, in that case, the transparency of the resulting material can be compromised by the mismatch between the refractive index of the inorganic filler and refractive index of the polymeric composition.

In order to improve the transparency of composite materials, mixtures of curable polymeric compositions with different refractive indexes were described, obtained by adjusting the composition of the mixture and aligning its overall refractive index with the refractive index of the filler.

For example, patent EP 1 477 529 describes a composite material, comprising a transparent resin and a glass filler. The transparent resin is a co-polymer obtained by (i) a monomer having a refractive index lower than glass, represented fey alicyclic structures containing acrylate/methacrylate, and by (ii) a monomer having a refractive index higher than glass, represented by (a) sulfur containing (meth)acrylates or (b) (meth)acrylate containing a backbone of 9,9′-bis(4-hydroxyphenyl)fluorene. The final composite material shows a low coefficient of linear expansion. The thermal resistance, measured by the Tg of the composite (Glass Transition Temperature): is found close to 250° C.

Additionally, patent WO 2009/104786 describes a composite material with high transparency, comprising a substrate of glass fibers impregnated by a resin composition. Such resin composition comprises a resin of cyanate ester (having index of refraction higher than glass fibers) and an epoxy resin (having an index of refraction lower than glass fibers), mixed in a certain ration in order to obtain an overall index of retraction close to glass fibers. The Tg (Glass Transition Temperature) disclosed in the examples for these materials is always lower than 245° C.

Finally, patent EP 1 524 301 describes a composite material comprising a resin and glass fibers where the inventors aim at matching the refractive indexes of the resin and the glass fibers across the full range of the visible spectrum (400-800 nm). The issue evidenced by this patent concerns with the variability of the value of the refractive index as a function of the wavelength of the light source used for the measure.

### SUMMARY OF THE INVENTION

Devices incorporating electronic displays based on plasma, liquid crystals, LED or organic LEDs or other optical interfaces have reached a considerable commercial success in the recent years: the supports used in those devices could be advantageously made of composite films. As such, the need for composite films showing improved properties then available materials has grown.

Generally, the composite films suitable as supports in the manufacturing of displays in several types of electronic and optical devices should have low coefficient of linear thermal expansion, high transparency, high solvent resistance and high glass transition temperature (Tg), which implies high thermal resistance.

Now, the Applicant has found that it is possible to obtain a composite film exhibiting the above mentioned features using a specific composition disclosed in the present invention.

The composite film of the present invention is made of a substrate of inorganic fibers, preferably glass or ceramic fibers, impregnated by a resin obtained by the polymerization of at least two monomers. Alternatively, the composite film of the present invention is made of a combination of resin, inorganic fibers and inorganic particles, for example silica, having nanometric size and carrying a surface coaling to enhance their compatibility with the resin.

One of the two monomers of the resin is an ester or an ether of 9,9′-bis(4-hydroxyphenyl)fluorene or an ethoxylated derivate, having an index of refraction (i.r.) higher than the inorganic fibers; the second monomer is a derivate triazinetrione with at least a polymerizable substituted group and having an index of refraction (i.r.) lower than the inorganic fibers.

The mixture of these two monomers, in a suitable ratio, yields a resin showing an index of refraction very close to the inorganic fibers.

Consequently, the Applicant found the composite film according to the present invention showed a high transparency across the full range of visible light (400 nm-800 nm).

Specifically, the Applicant found the composite film shows an average light transmittance, in the range between 400 and 800 nm, higher than 80%, preferably higher than 85%.

Additionally, the Applicant found that the composite film according to the present invention has an improved thermal resistance, with an onset Tg higher than or equal to 280° C., preferably higher than or equal to 300° C. and more preferably higher than or equal to 350° C.

Moreover, the Applicant found that the composite film according to the present invention showed a peak value of the tanDelta curve higher than 325° C., preferably higher than 345° C., and more preferably higher than 365° C.

The improved thermal resistance is an advantage in the deposition process, usually performed at high temperature, of the functional layers onto the film support. Higher temperature, in fact, allows manufacturing electronic display devices of excellent qualify on plastic substrates, without significant modifications of existing production lines, normally utilizing glass substrates.

The Applicant also found that the composite film according to the present invention has high dimensional stability, showing a low coefficient of linear expansion, specifically measured in the range between 30° C. and 150° C., lower than or equal to 30 ppm/° C., preferably lower than or equal to 20 ppm/° C., more preferably lower than or equal to 15 ppm/° C.

Additionally, the Applicant found that the composite film disclosed in the present invention has a high resistance to organic solvents and other chemical products used in the manufacturing of electronic devices.

Finally, the Applicant found that the composite material disclosed in the present invention can be used also in non flexible forms, retaining their transparency, thermal resistance and dimensional stability. Because of the presence of the reinforcing fibers, the composite material shows high mechanical strength as well and, thanks to their high thermal resistance, i.e. their very high Tg value, they also exhibit a high surface hardness. Additionally, it is known in the art that composite materials incorporating reinforcing glass clothes do not break in harmful pieces, as a consequence of structural failure, under a violent impact. As such, large fragments potentially source of injuries are prevented, for example, in case of car accidents, as the embedded cloth in windshields keeps the fragments in place and avoid the formation of lose pieces with sharp edges.

Then, a first embodiment of the present invention relates to a composite film or a layered material composing a substrate (A) made of inorganic fibers impregnated by a resin: obtained by the polymerization of a composition (B) made of:
a first monomer (B1) Having an index of refraction higher than said inorganic fibers, said first monomer (B1) being selected from the group consisting of (i) esters of 9,9′-bis(4-hydroxyphenyl)fluorene or its ethoxylated derivate with crotonic acid or its derivates or crotonic acid or its derivates, (ii) mixed esters of 9,9′-bis(4-hydroxyphenyl)fluorene or its ethoxylated derivate with cinnamic acid or its derivates and acrylic or methacrylic acid, (iii) mixed esters of 9,9′-bis(4-hydroxyphenyl)fluorene or its ethoxylated derivate with crotonic acid and acrylic or methacrylic acid, (iv) ethers of 9,9′-bis(4-hydroxyphenyl)fluorene or its ethoxylated derivate with allylic alcohol (v) monoesters of 9,9′-bis(4-hydroxyphenyl)fluorene monoallylether or its ethoxylated derivate with cinnamic acid or its derivates, or crotonic acid or its derivates, or acrylic or methacrylic acid; and
a second monomer (B2) having an index; of refraction lower than the inorganic fibers, said second monomer (B2) consisting of a triazinetrione derivate having at least one polymerizable substituted group.

Advantageously, composition (B) optionally includes an inorganic filler (C) preferably made of functionalized silica and/or alumina particles. The nominal size of the particles constituting the filler (C) is smaller than 0.001 mm in diameter.

Additionally, a second embodiment of the present invention concerns with a resin obtained by the polymerization of a composition (B) comprising:
a first monomer (B1) selected from the group consisting of (i) esters of 9,9′-bis(4-hydroxyphenyl)fluorene or its ethoxylated derivate with cinnamic acid or its derivates or crotonic acid or its derivates, (ii) mixed esters of 9,9′-bis(4-hydroxyphenyl)fluorene or its ethoxylated derivate with cinnamic acid or its derivates and acrylic or methacrylic acid, (iii) mixed esters of 9,9′-bis(4-hydroxyphenyl)fluorene or its ethoxylated derivate with crotonic acid and acrylic or methacrylic acid (iv) ethers of 9,9′-bis(4-hydroxyphenyl)fluorene or its ethoxylated derivate with allylic alcohol, (v) monoesters of 9,9′-bis(4-hydroxyphenyl)fluorene monoallylether or its ethoxylated derivate with cinnamic acid or its derivates, or crotonic acid or its derivates, or acrylic or methacrylic acid; and
a second monomer (B2) consisting of a triazinetrione derivate having at least one polymerizable substituted group.

Advantageously, composition (B) optionally includes an inorganic filler (C) preferably made of functionalized silica and/or alumina particles. The nominal size of the particles constituting the filler (C) is smaller than 0.001 mm in diameter.

### SHORT DESCRIPTION OF THE FIGURES

FIG. 1 is a Cartesian plot showing the storage modulus curve and the TanDelta curve measured at increasing temperatures of the composite film of Example 3.

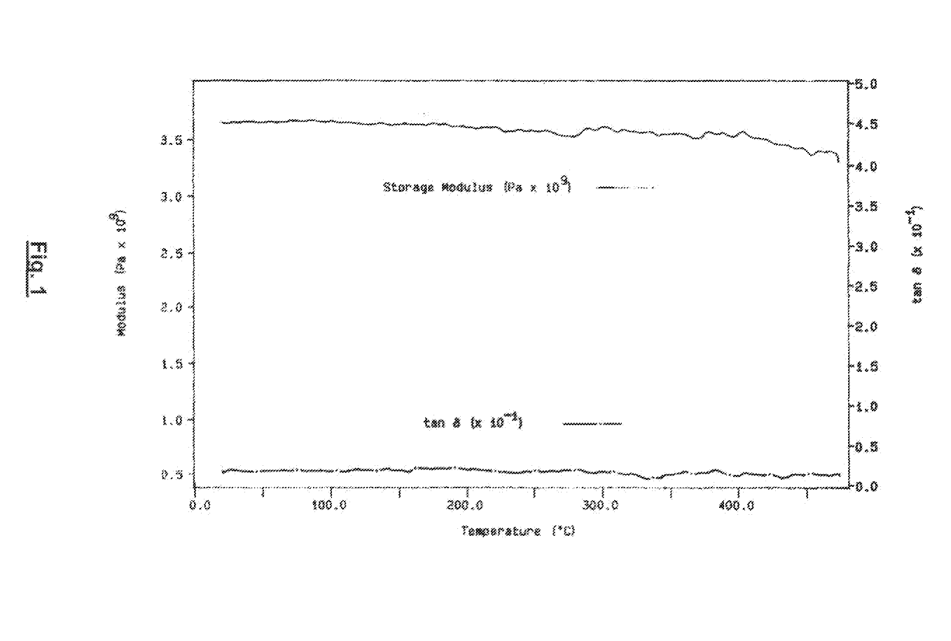

FIG. 2 is a Cartesian plot showing the storage modulus curve and the TanDelta curve measured at increasing temperatures of the composite film of Example 4.

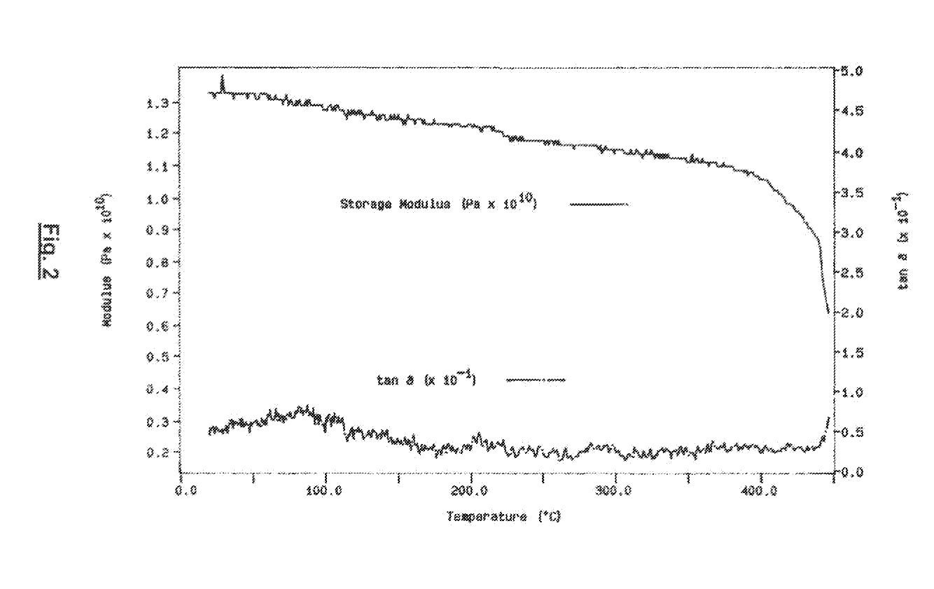

FIG. 3 is a Cartesian plot showing the storage modulus curve and the TanDelta curve measured at increasing temperatures of the composite film of Example 5.

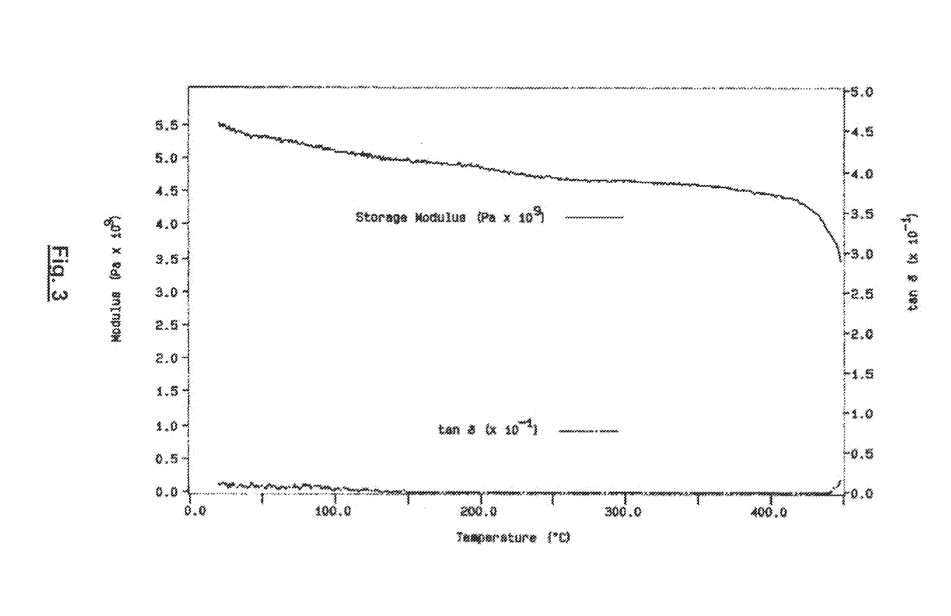

### DETAILED DESCRIPTION OF THE INVENTION

In details, substrate (A) made from inorganic fibers comprises glass fibers and/or ceramic fibers. Substrate (A) made from inorganic fibers can comprise woven or non-woven fibers, or alternatively, can comprise chopped fibers Substrate (A) made from glass fibers and/or ceramic fibers can be chosen among many materials commercially available, including, for example, Nittobo style 106, 3M Nextel, Unitika #1015 and others. The index of refraction of substrate (A) is preferably in the range from 1.45 to 1.70. Advantageously, the substrate made from inorganic fibers attributes to the composite film described in the present invention its dimensional stability.

The values of refractive index of the first monomer (B1) and of the second monomer (B2), respectively higher than and lower than the refractive index of the substrate (A) made from inorganic fibers, is measured on two homo-polymers consisting respectively entirely of the monomer (B1) and entirely of the monomer (B2). The value of the refractive index of the resin is measured on the co-polymer obtained by the polymerization of the composition (B) comprising monomers (B1) and (B2) and eventually the filler consisting of inorganic particles (C). Advantageously, the difference between the refractive index of the substrate (A) and the refractive index of the resin (B), either including or not the inorganic particles (C), is equal to or lower than 0.01.

Preferably, the first monomer (B1) is represented by the following generic formulae (B1-i) and (B1-ii). More preferably, the first monomer is represented by the generic formula (B1-i).

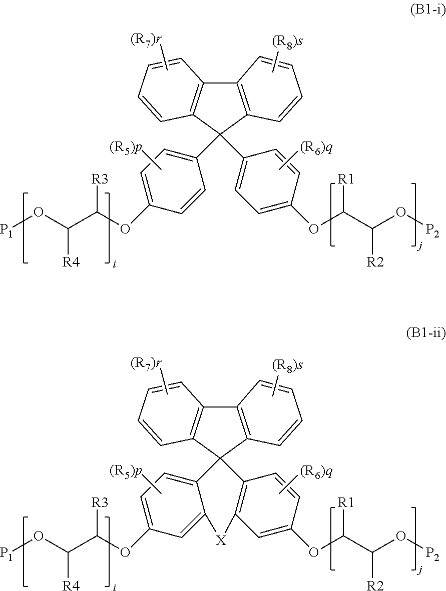

wherein,

R₁, R₂, R₃, and R₄, equal or different, each independently is a hydrogen atom or an alkyl group having 1 to 3 carbons,

i and j are integers from 0 to 4, whose sum is equal to or lower than 4;

R₅, R₆, R₇, and R₈, equal or different, each independently is a hydrogen atom; a halogen atom; an alkyl group with 1 to 6 carbons; a cycloalkyl group with 3 to 6 carbons; an alkoxy group with 1 to 6 carbons; an aryloxy group with 6 to 12 carbons; a haloalkyl group —CₙY_{z}H_{(2n+1-z)} where Y is selected from the group consisting of fluorine, chlorine, bromine and iodine, n is an integer from 1 to 12 and z is an integer from 1 to (2n+1); a carbonyl group —COR, an ester group —OCOR or —COOR where is an alkyl group having 1 to 6 carbons;

p, q, r, s, are integers from 0 to 4 in formula (B1-i);

p, q, are integers from 0 to 4 and r, s are integers from 0 to 3 in formula (B1-ii);

X is a divalent radical selected from the group consisting of O, S, or a —CR₁₀R₁₁ alkylidene group, wherein R₁₀ and R₁₁, equal or different, each independently is a hydrogen atom or an alkyl group having 1 to 3 carbons;

P₁ and P₂, equal or different, each independently is a polymerizable group comprising a double bond selected from the group consisting of:

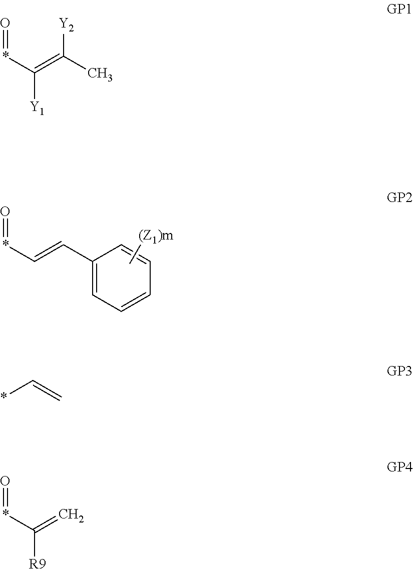

wherein,

* represents the carbon bound to the oxygen

Y₁ and Y₂ equal or different each independently is a hydrogen atom or an alkyl group having 1 to 3 carbons:

Z₁ is a hydrogen atom; a halogen atom; an alkyl group having 1 to 6 carbons; a cycloalkyl group having 3 to 6 carbons; an alkoxy group having 1 to 6 carbons; an aryloxy group having 6 to 12 carbons; a halolkyl group —CₙY_{z}H_{(2n+1-z)} where Y is selected from the group consisting of fluorine, chlorine, bromine and iodine, n is an integer from 1 to 12 and z is an integer from 1 to (2n+1); a carbonyl group —COR, an ester group —OCOR or —COOR, where R is an alkyl group having 1 to 6 carbons; and m is an integer from 0 to 5; and

R9 is a hydrogen atom or a methyl group;

with the proviso that at least one of P₁ and P₂ is different than GP4 group.

Examples of monomers (B1-i) and (B1-ii), suitable according to the present invention, include:

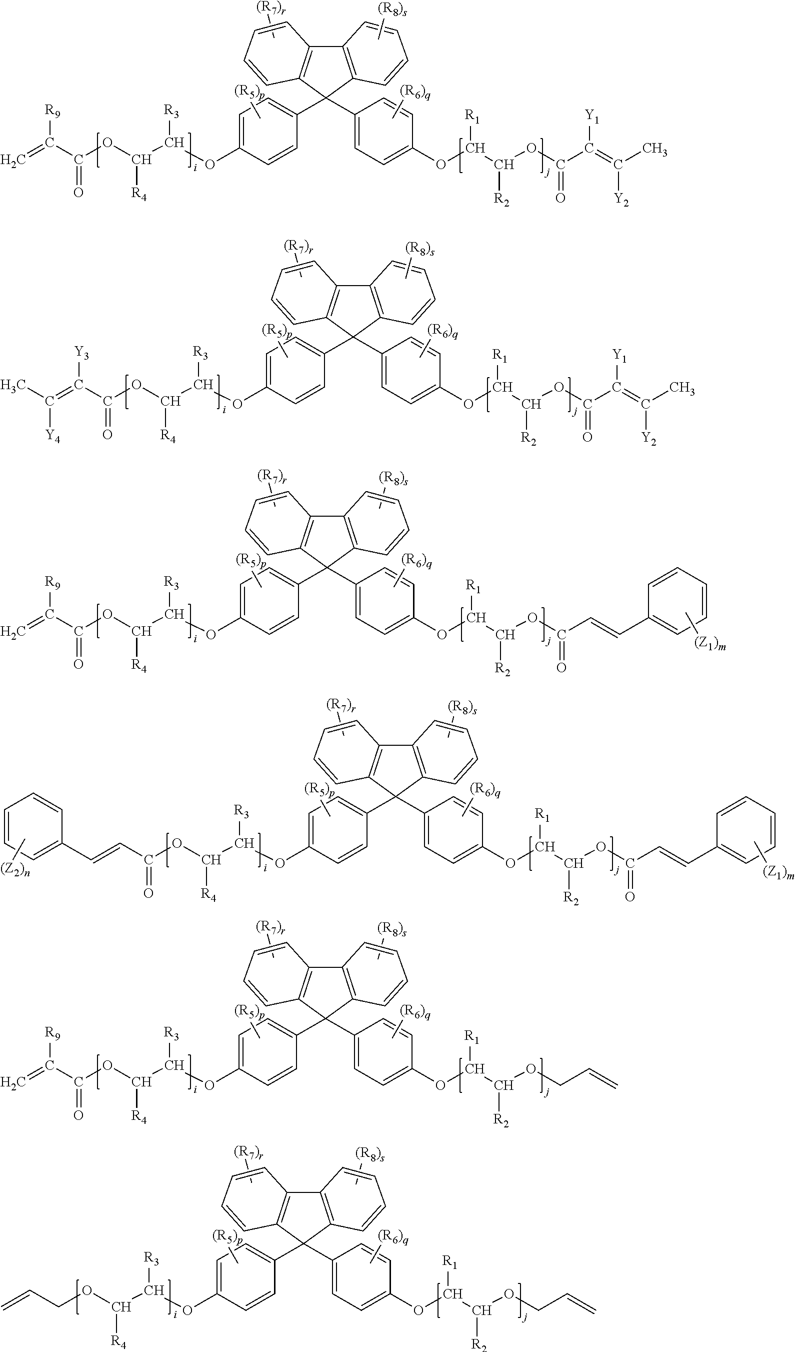

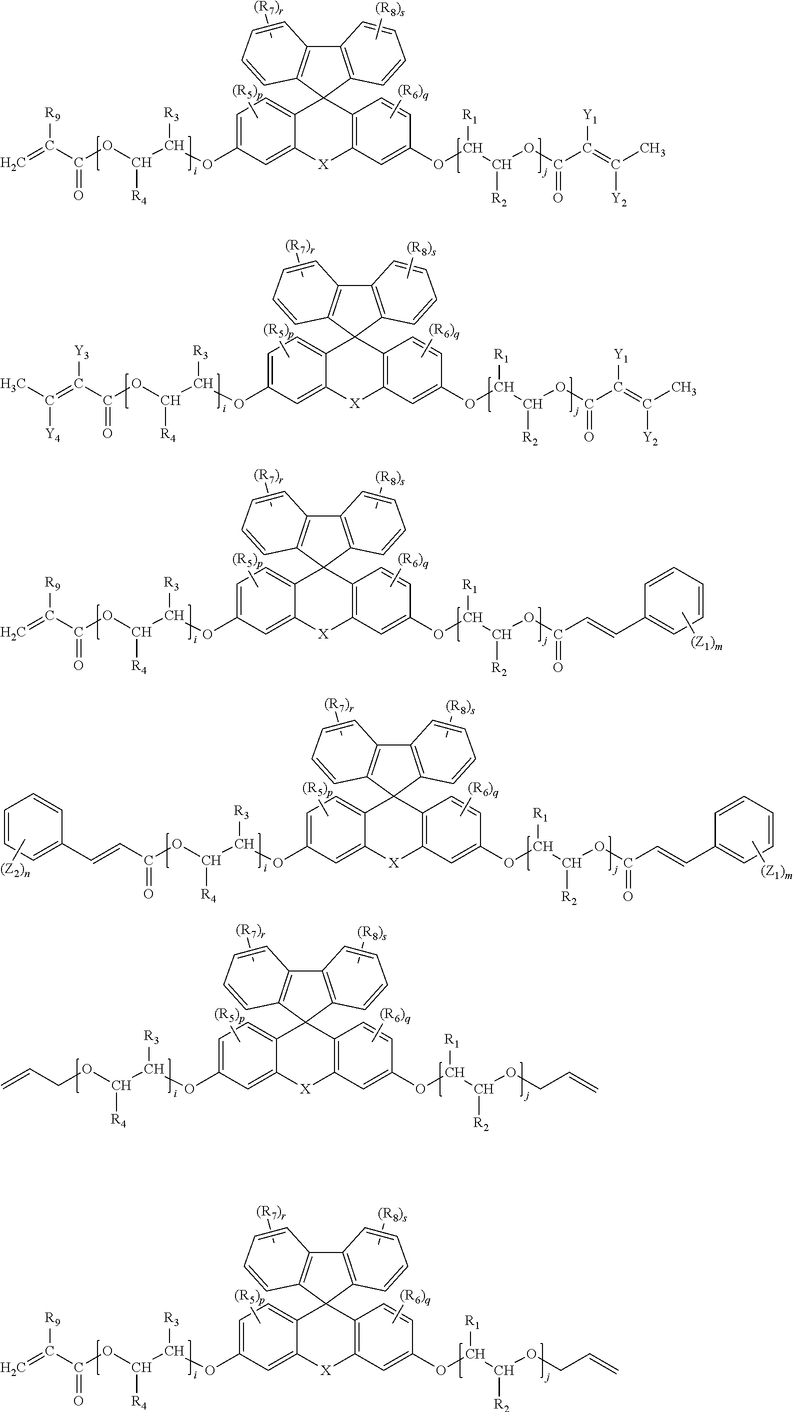

wherein,

R₁, R₂, R₃, R₄, R₅, R₆, R₇, R₈, R₉, X, have the meaning above specified,

i, j, p, q, r, s, are integer numbers above defined;

Y₁, Y₂, Y₃ and Y₄, equal or different, each independently is a hydrogen atom or an alkyl group having 1 to 3 carbons;

Z₁ and Z₂, equal or different each independently is a hydrogen atom; a halogen atom; an alkyl group having 1 to 6 carbons; a cycloalkyl group having 3 to 6 carbons; an alkoxy group having 1 to 6 carbons; an aryloxy group having 6 to 12 carbons; a haloalkyl group —CₙY_{z}H_{(2n+1-z)} where Y is selected from the group comprising fluorine, chlorine, bromine and iodine, n is an integer from 1 to 12 and z is an integer from 1 to (2n+1); a carbonyl group —COR, an ester group —OCOR or —COOR, where R is an alkyl group having 1 to 6 carbons; and m is an integer from 0 to 5.

According to a preferred embodiment of the present invention, R₁, R₂, R₃ R₄, equal or different, each independently is a hydrogen atom or a methyl group.

Advantageously, R₅, R₆, R₇, R₈, equal or different, each independently is a hydrogen atom, a halogen atom or an alkyl group having 1 to 3 carbon atoms.

Preferably, Z₁ and Z₂ are both a hydrogen atom.

More preferably, X is a divalent radical selected from oxygen and sulfur

i and j are preferably each independently equal to 0 or 1.

p, q, r, and s are preferably equal to 4 in formula (B1-i).

p and q are preferably equal to 4, and r and s are preferably equal to 3 in formula (B1-ii).

Specifically, the first monomer (B1) yields better transparency and higher glass transition temperature T_{g} of the resin, obtained by composition (B). A higher T_{g} value provides higher thermal resistance to the composite film described in the present invention.

The second monomer (B2) is represented by derivates of triazinetrione having the following generic formula:

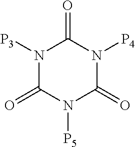

where P₃, P₄, and P₅, equal or different, represent polymerizable groups comprising a double bond or a non-polymerizable group,

with the condition that at least one of P₃, P₄, and P₅ must be a polymerizable group comprising a double bond.

Preferably, the non-polymerizable group is selected from the group consisting of an alkyl group having 1 to 6 carbons; a cycloalkyl group having 3 to 6 carbons; a haloalkyl group —CₙY_{z}H_{(2n+1-z)} where Y is fluorine, chlorine, bromine or iodine, n is an integer from 1 to 12, and z is an integer from 1 to (2n+1); an alkyl group having 1 to 6 carbons substituted by a nitrile group (—CN), carbonyl group (—COR), or ester group (—OCOR o-COOR where R is an alkyl group having 1 to 6 carbons); a polyalkylenoxy group (—((CH₂)_{w}-O)ₓ-H, where w and x, are, independently, integer numbers from 1 to 3).

Preferably, the polymerizable group is selected from the group consisting of allyl group, allylether group, vinylether group or a derivate thereof, ester of the cinnamic acid or a derivate thereof, ester of the crotonic acid or a derivate thereof, ester of the 3-alkoxy-propanoic acid or a derivate thereof.

The second monomer (B2) preferably comprises at least two polymerizable groups, more preferably all P₁, P₂, and P₃, equal or different, are polymerizable groups comprising a double bond.

Examples of said second monomer (B2), suitable according to the present invention, include:

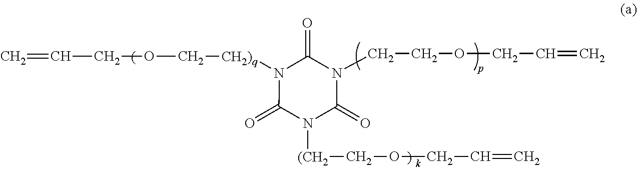

where

p, k and q are integer number, from 0 to 6, whose sum is equal to or lower than 6;

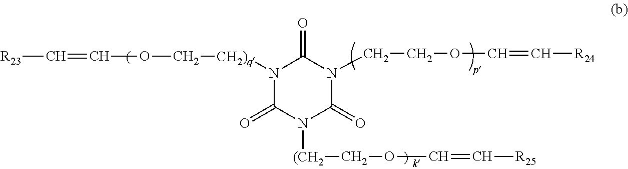

where

R₂₃, R₂₄ and R₂₅, equal or different, independently represent hydrogen, an alkyl group from 1 to 3 carbons, a phenyl group, or an aryl group optionally substituted;

p′, k′ and q′ are integer numbers from 1 to 4, whose sum is equal to or comprised between 3 and 6;

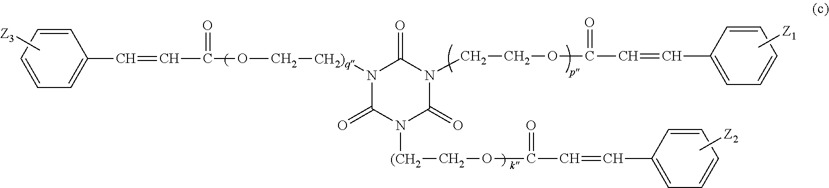

where

Z₁, Z₂ and Z₃, equal or different, independently represent hydrogen; a halogen; an alkyl group, having 1 to 6 carbons; a cycloalkyl group having 3 to 6 carbons, an alkoxy group having 1 to 6 carbons; an aryloxy group having 6 to 12 carbons; a haloalkyl group —CₙY_{z}H_{(2n+1-z)} where Y is selected from the group consisting of fluorine, chlorine, bromine and iodine, n is an integer from 1 to 12 and z is an integer from 1 to (2n+1); a carbonyl group —COR, an ester group —OCOR or —COOR, where R is an alkyl group having 1 to 6 carbons;

p″, k″ and q″ are integer numbers from 1 to 4, whose sum equals to or is comprised between 3 and 6;

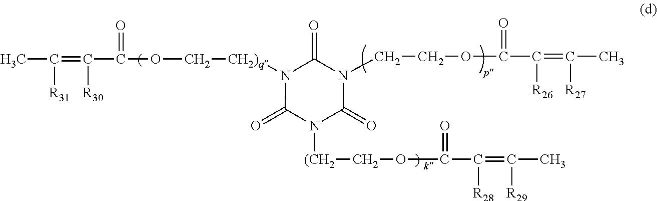

where

R₂₆, R₂₇, R₂₈, R₂₉, R₃₀, and R₃₁, equal or different, independently represent hydrogen or an alkyl group having 1 to 3 carbons;

p″, q″ and k″ are integer numbers from 1 to 4, whose sum equals to or is comprised between 3 and 6;

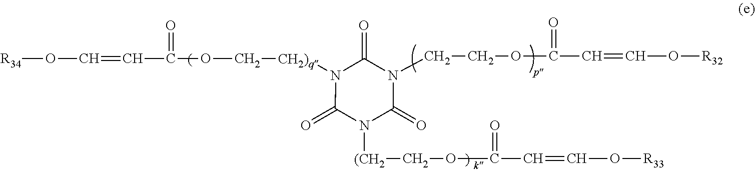

where

R₃₂R₃₃, and R₃₄, equal or different, independently represent an alkyl group having 1 to 6 carbons or a cycloalkyl group having 3 to 6 carbons;

p″, q″, and k″ are integer numbers from 1 to 4, whose sum is equal to or comprised between 3 and 6.

Specifically, the second monomer (B2) allows adjusting the refractive index of the resin obtained by the composition (B) and contributes to provide high thermal resistance to the composite film described in the present invention.

Advantageously, especially when the monomers B1 and B2 comprise double bonds with low reactivity, the composition (B) can include one or more additional polythiol monomers (B3) participating in the polymerization. The polythiol monomer (B3) co-polymerizes with the first and the second monomer (B1 and B2) and contributes to adjusting the refractive index of the resin resulting from the polymerization (B).

Preferably, the polythiol monomer (B3) is selected from the group consisting of polythiols containing at least two thiol functional groups.

More preferably, said polythiol monomer (B3) is selected from the group consisting of thiobenzen-thiol; dimercapto biphenyl; tricyclodecane dimethanthiol; dithiolic derivates of bisphenol A, such as for example the monomer represented by formula

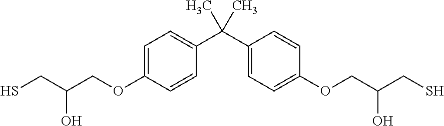 [SMILES: CC(C)(c1ccc(OCC(O)CS)cc1)c1ccc(OCC(O)CS)cc1]

dithiolic derivates of fluorene bisphenol, such as for example the monomers represented by formulae

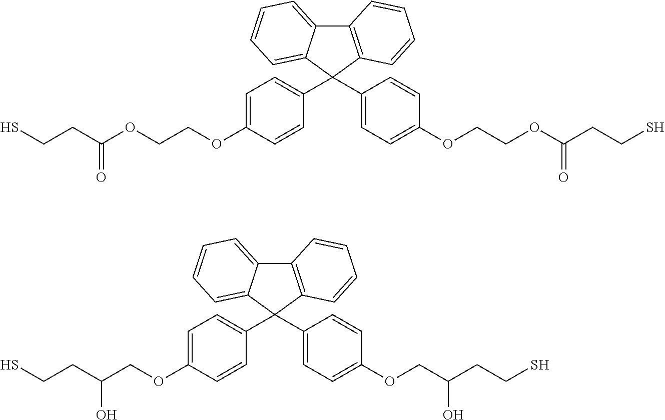 [SMILES: O=C(CCS)OCCOc1ccc(C2(c3ccc(OCCOC(=O)CCS)cc3)c3ccccc3-c3ccccc32)cc1 ; OC(CCS)COc1ccc(C2(c3ccc(OCC(O)CCS)cc3)c3ccccc3-c3ccccc32)cc1]

polythiolic derivates of trivalent isocyanurate, for example tris-(3-mercaptopropyl) isocyanurate, tris(2-hydroxyethyl) isocyanurate tris(3-mercaptopropionate), trimethylolpropane tris(3-mercaptopropionate), and pentaerythritol tetrakis(3-mercaptopropionate).

Advantageously the composition (B) can include an inorganic filler, such as silica and/or alumina particles having nanometric size, used to improve the resistance of the material against surface scratches, to reach a bettor dimensional stability of the final composite film and to improve its optical properties. Preferably, the silica and/or alumina particles are functionalized by cross-linkable residues, such as for example acrylate or methacrylate or epoxy groups able to take part in the cross-linking of composition (B).

Preferably, the composition (B) includes a reactive thinner, used to reduce the viscosity or dissolve the mixture of the monomers (B1, B 2, and optionally B3) and, therefore, to facilitate the co-polymerization of the blend of monomers B1 and B2, and optionally of monomer B3.

The reactive thinners are liquid monomers having very low viscosity at room temperature, able to react with other monomers during the polymerization. The amount of reactive thinner is less than 10% by weight preferably less than 5% by weight, in the total weight of composition (B). The amount of reactive thinner should be as low as possible in order to prevent detrimental effects on the overall performance of the composite film, especially on its thermal resistance. The reactive thinners are generally acrylates or methacrylates having low viscosity such as, for example, methylacrylate, methylmethacrylate and ethylmethacrylate.

Preferably, said composition (B) can include an initiator of the polymerization. The initiator of the polymerization is chosen among photo-initiators, thermo-initiators or their blends.

The amount of initiator added to the composition according to the present invention changes with the nature of the composition of the monomers (B1, B2 and optionally B3) and can be defined by a person skilled in the art according to the specific needs.

Nevertheless in order to prevent a residual coloration induced by the degradation of the initiator, it is required that the initiator amount does not exceed 6% by weight in the total weight of composition (B).

If the polymerization is obtained by photo curing only, the composition (B) must be exposed to a suitable activation energy source.

Suitable activation energy sources emit ultraviolet or visible Radiation, for example metallic halide lamps, low pressure and/or high pressure mercury lamps, and the like.

Examples of photo-initiators, known in the art, can be found in Irgacure® and Darecur® series commercially available from Ciba®, and in Lucirin® series commercially available from BASF Company. For example: Irgacure®1700 (25/75 blend of bis(2,6-dimethoxyibenzoyl)-2,4,4-trimethyl-pentylphosphinoxide and 2-hydroxy-2-methyl-1-phenyl-propan-1-one); Irgacure®1800 (25/75 blend of bis(2,6-dimethoxybenzoyl)-2,4,4-trimethyl pentylphosphinoxide and 1-hydroxy-cyclohesyl-phenylketone); Irgacure® 184 (1-hydroxy-cyclohexylphenylketone); Lucirin® TPO (2,4,6-trimethyl benzoyl-diphenylphosphinoxide) and Lucirin® TPO-L (ethyl-2,4,6-trimethylbenzoyl-phenyl phosphinate).

If the polymerization is obtained by thermal curing only, the composition (B) includes preferably thermal initiators able to generate radicalic chains under exposure to heat.

The thermo-radicalic curing initiators are not limited. Useful examples include diacyl peroxides, for example benzoyl peroxide, lauryl peroxide, acetyl peroxide; peroxide esters such as, for example, ter-buthylperoxide benzoate; or azo compounds such as for example 2,2′-azobis(2-metylpropyonytrile) known as AIBN, 4,4′-azobis (cyanovaleric) acid and 1,1′-azobis(cyclohexancarbonitrile).

If the polymerization is obtained by a combination of photo and thermal curing, the polymerization process is done in two steps, using, preferably, the photo-initiator to trigger the polymerization and the thermo-initiator to complete the polymerization.

Other energy sources can be advantageously used such as electronic guns E-Beam, infrared radiation (IR) and microwaves.

The procedure to prepare the composite film according to the present invention is not limited and can be chosen among those known in the art.

Advantageously, the glass fibers in substrate (A) is calcinated at temperatures up to 700° C., to remove the sizing agents added during the manufacturing process, and the surface of the glass fibers (A) is coated by a surface agent, for example an acrylic silane or a methacrylic silane such as the acryloyloxypropyltriethoxysilane by Sigma Aldrich.

The resulting substrate (A) can be impregnated by the composition (B) by means of techniques known in the art.

The composition (B) is prepared blending the monomer (B1) having high refractive index and monomer (B2) having law refractive index in suitable ratio for the composition (B), after the curing process, to have an index of refraction as close as possible to the glass fibers, in particular, the weight on weight ratio of the monomer (B1) and the monomer (B2) is from 10:90 through 90:10.

If the monomer (B1) is a solid or a highly viscous liquid, it could be advantageous using a suitable thinner, respectively, to dissolve if or reduce its viscosity. Advantageously, useful examples of suitable thinners are volatile solvents like methanol, methylene chloride, acetone, tetrahydrofurane, methylethylketone, o their mixtures.

The operating procedure for the preparation of the materials and the composite films described in the present invention is known in the art and broadly published. An example of a possible operating procedure, even if the same results can be achieved by other techniques, is described in “Principles of the Manufacturing of Composite Materials”, by DEStech Publications, Inc. (2009), in a paragraph focused on hand lamination (Part II: Techniques for composites manufacturing. Chapter 4—Hand Laminating). The process starts with the preparation of a flat support with a smooth surface and treated by a suitable release agent, in order to facilitate the detachment of the resin after curing. Advantageously, the support can be a glass sheet and the release agent can be selected among many products commercially available for that use. One or more layers of reinforcing material to form the substrate (A), advantageously made of woven or not woven fibers, are then deposited on the support. More specifically, in the present invention the Applicant used glass clothes generally employed in the preparation of flexible supports for printed circuit boards. Those glass clothes are listed, for example, in IPC standards, globally adopted by the electronic industry and a suitable product is identified by code 106 and is commercially available from several manufacturers including Nittobo and Unitika in Japan. In order to make composite films of the desired thickness, a possible approach is to use more layers of thin glass cloth (for example NITTOBO IPC 106, having a thickness of 35 micrometer) or single layers of thicker glass cloth (for example NITTOBO IPC 3313, having a thickness of 83 micrometri). Alternatively, instead of glass cloths, ceramic materials can be used, such as Nextel manufactured by 3M Company. A second reason for using a certain type of substrate (A) is the desired ratio between the amount or resin of composition (B), and the amount of reinforcing material (i.e. for example glass), expressed by the weight fraction of the two components (A) and (B) per unit film surface. The resin of composition (B) is then spread over the glass cloth(es), homogeneously distributing it on the support and the substrate (A). A possible way to reach a better impregnation of the substrate (A) by the resin (B) and to prevent the formation of air bubbles during the preparation of the composite material a film of polyester or other transparent polymeric film coated by a release agent can be placed on the top of the composite film, using a hand roller, the top film can be applied with a controlled pressure starting from an edge of the composite film and running the roller across its width, to distribute and homogenize the resin, remove resin in excess and facilitate the removal of air pockets. Eventually, the composite film can be placed temporarily under vacuum to remove air bubbles trapped among the glass fibers, in such a case, before positioning the polyester film, a sheet of a suitable porous material, coated by a release agent, can be inserted between the surface of the resin and the polyester film, to vent the trapped air. If the monomer (B1) is dissolved or diluted in a suitable solvent, the latter should be removed by evaporation before curing, for example by heating the composite film under vacuum.

When the composition (B) comprises functionalized nanometric silica, the particles are generally dispersed in a volatile solvent removable, for example, by thermal evaporation or under vacuum during the preparation of the composite film.

A second glass sheet can be positioned on top of the stack of composite film, porous film and polyester film to obtain a flat surface, as the surface resin is liquid. By the described process, it is possible to obtain a semi-finished product made of one or more layers of substrate (A) impregnated by composition (B), supported between two glass sheets.

The supported composite film can be cured by, for example, ultraviolet (UV) radiation. Other suitable methods to cure the film include exposure to heat, microwaves, E-Beam. The composite film can be treated under pressure in the curing process or in a following step, eventually using a heated press and after removal of the polymeric films, for a time from 1 to 24 hours. The temperature of the press can be preferably between 90° C. and 400° C., the applied pressure can be between 0.1 MPa and 20 MPa. Inert gas or vacuum can be used to prevent oxidation induced by high processing temperatures.

When the curing is complete, the composite film acquires a solid not-sticky surface. The final step in the preparation process of the material described in the present invention is the removal of the glass supports and eventually of the polymeric films, If any. The resulting composite film can be heated at a temperature from 150° C. to 400° C. in inert atmosphere for a suitable time required to stabilize the resin, preferably for a time from 15 minutes and 36 hours. Such treatment approaches 100% conversion of the polymerizable groups and relaxes the internal stresses developed during the lamination steps and the natural shrinking of the resin caused by the curing process.

The following examples are given to describe the present invention in further details, without limiting it in any way.

### EXAMPLES

### Example 1

Synthesis of Monomer (B1-i).

The monomer (B1-i) used in the present invention can be prepared by commercially available starting materials and the synthesis methods known in the art, such as, for example, by the reaction routes described herein below.

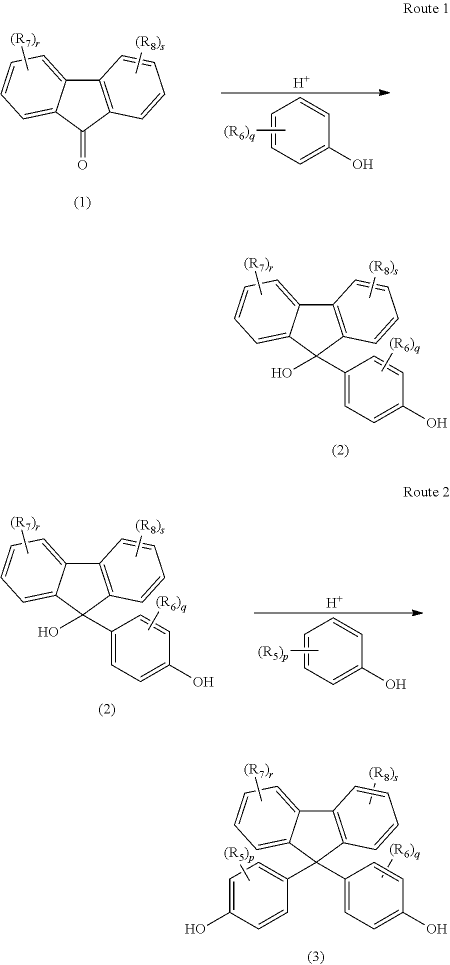

The reaction employs methanesulphonic acid as an acid catalyst, in toluene as a suitable solvent. The intermediate product 2 is not isolated and the reaction proceeds in two steps at two different temperatures: the first step requires 8 hours at 40° C. the second step requires 3 hours at 65° C. The product is purified by a double crystallization in toluene/acetonitrile to obtain the pure compound 9,9′-bis(4-hydroxyphenyl) fluorene (BHPF) or its substituted derivates.

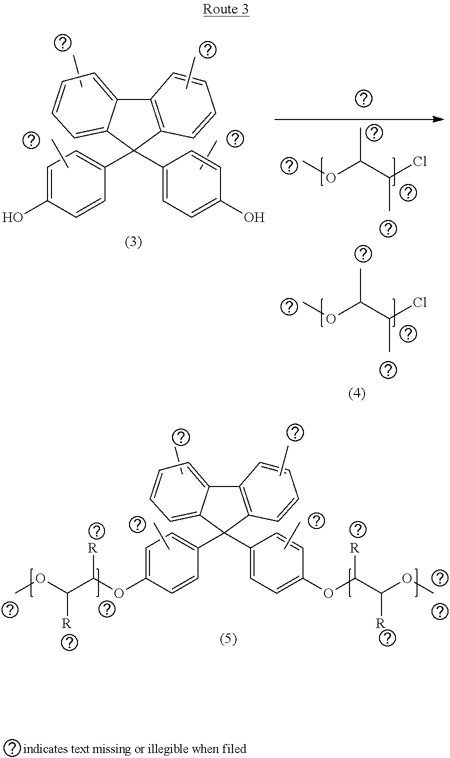

The reagent 3, BHPF or its substituted derivates is dissolved in tert-butanol and cooled to 25° C. Then, potassium terbutylate dissolved in methanol is added and finally the reagent 4 is added. The reaction is maintained under reflux of solvent for a time from 3 hours and 24 hours. After extraction and washing, the solid product 5 can be used as it is or re-crystallized.

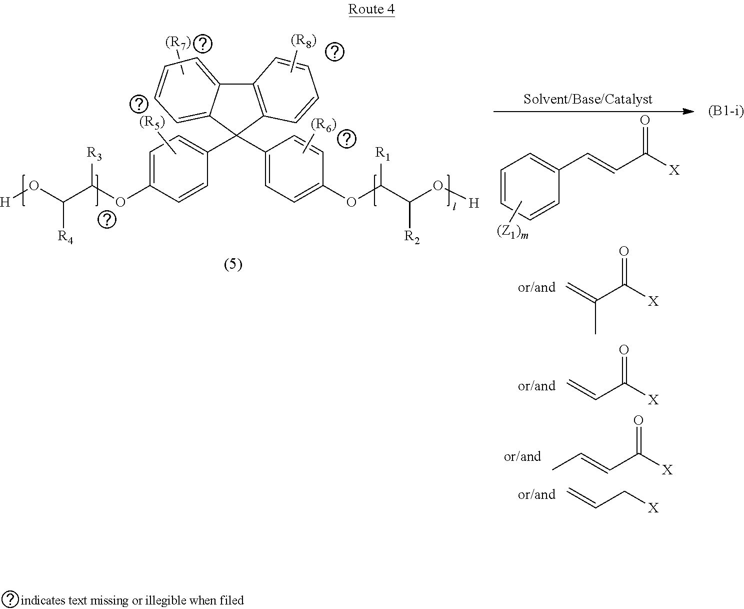

The reagent 5 is dissolved in a suitable solvent under stirring and in nitrogen atmosphere. The solvent can be acetone, ethyl acetate, acetonitrile, or methylene chloride. Then, the solution is cooled to room temperature and the base triethylamine is added. The proper halide (crotonate, cinnamate, acrylate, methacrylate and or allyl), preferably the chloride, eventually substituted by the groups Z, dissolved in the same solvent, is slowly added by the drop. The triethylamine chlorhydrate precipitate is removed by filtration and the reaction product, the monomer B1-i, is extracted by a volatile solvent immiscible with water (methylene chloride, ether, or ethyl acetate) and then washed with acid water (1% chlorhydric acid) to eliminate the residual triethylamine, basic water (1% sodium hydroxide) to eliminate the impurities of crotonate chloride and crotonic acid and, finally, with deionized water. After the anhydrification of the organic phase containing the product B1-i and the evaporation of the solvent, the reaction product is recrystallized by solvent several times to remove the remaining traces of impurities, when the product is solid. If the product is liquid or waxy, it is precipitated and separated several times by decanting.

### Example 2

Synthesis of Monomer (B1-ii)

The spyro BHPF was obtained by the following procedure:

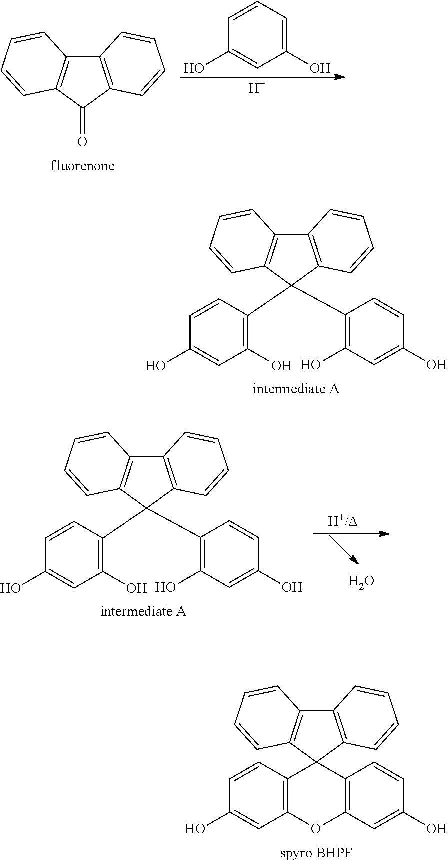

The reagents fluorenone and resorcinol are dissolved slowly in glacial acetic acid at 40° C. with the acid catalyst, a mixture of marcaptopropionic acid and methansulphonic acid. The intermediate product A is not isolated, and the reaction mixture is stirred and heated for 24 hours at 75° C. The product spyro BHPF is precipitated in water and re-crystallized. From the spyro BHPF it is possible to obtain the monomer (B1-ii) by the route described herein below, using the procedure described in Example 1 (routes 3 and 4):

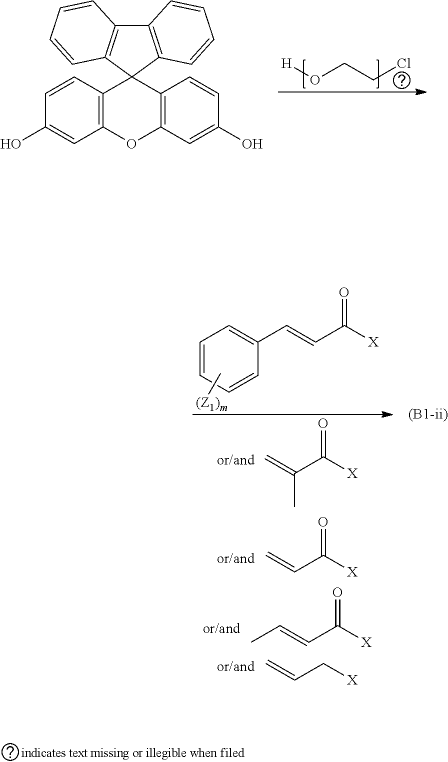

### Example 3

### Example of Preparation of the Composite Film

Four samples of glass sloth Unitika E02Z. (#1015), having a thickness of 15 μm and weight 17 g/m² were out to A4 size (21×30 cm) and calcinated at 700° C. for 4 hours to remove the surface sizing.

The four samples were wrapped around a Teflon shaft and stirred for 24 hours at 67° C. in a hydro-alcoholic solution of sylane A174 (3-methacryloxy-propyl-trimetoxy-silane).

Alter washing with ethyl alcohol and drying, the four glass cloth samples were stacked on a polyester (PET) film support and impregnated by a resin comprising 34.15% by weight of the monomer B1a (monocrotonic and monomethacrylic mixed diester of 9,9′-bis(4-hydroxypbenyl)fluorene), 63.41% by weight of the monomer B2a 1,3,5-Triazine-2,4,6(1H,3H,5H)-trion, 1,3,5-tri-2-propen-1yl- and 2.44% by weight of thermo-initiator Luperox P (tert-butylperoxy benzoate). The resin was previously dissolved in methylene chloride and the solvent was removed by evaporation after the impregnation of the glass cloth. A second sheet of PET film was placed over the clothes impregnated by the resin and the resulting multilayer product was laminated at room temperature.

The laminate was treated at 130-135° C. under nitrogen for 16 hours, supported between two glass sheets. The PET sheets were removed and the composite film, supported between two glass sheets, was treated again at 300° C. for 30 minutes under nitrogen.

After cooling to room temperature, a transparent composite film having a total thickness of 75 μm and a content of glass fibers close to 58% by weight.

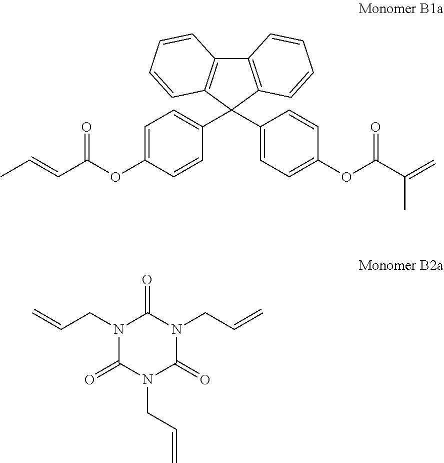

### Example 4

### Example of Preparation of the Composite Film

The procedure in example 3 was repeated using the monomer B1b, the crotonic diester of 9,9′-bis(4-hydroxyphenyl)fluorene) instead of monomer B1a. A transparent composite film was obtained having a total thickness of 75-80 μm with a content in glass fibers of 55.4% by weight.

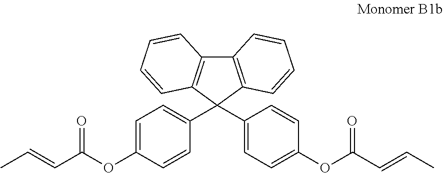 [SMILES: C/C=C/C(=O)Oc1ccc(C2(c3ccc(OC(=O)/C=C/C)cc3)c3ccccc3-c3ccccc32)cc1]

### Example 5

### Example of Preparation of the Composite Film

The procedure in example 3 was repeated using the monomer B1c (the monocrotonic and monoacrylic mixed diester of 9,9′-bis(4-hydroxyphenyl)fluorene) to replace the monomer B1a. A transparent composite film was obtained having a total thickness of 75-80 μm and a content in glass fibers of 55% by weight

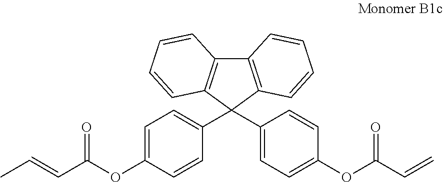 [SMILES: C=CC(=O)Oc1ccc(C2(c3ccc(OC(=O)/C=C/C)cc3)c3ccccc3-c3ccccc32)cc1]

### Comparative Example 1

Example of preparation of a composite film using other known monomers, not described in the present invention.

Four samples of glass cloth Unitika E02Z (#1015), having a thickness of 15 μm and weight 17 g/m² were cut to A4 size (21×30 cm) and calcinated at 700° C. for 4 hours to remove the surface sizing.

The four samples were wrapped around a Teflon shaft and stirred for 24 hours at 67° C. in a hydro-alcoholic solution of sylane A174 (3-methacryloxy-propyl-trimetoxy-silane).

After washing with ethyl alcohol and drying, the four samples were stacked on a PET film support and impregnated by a resin comprising 41% by weight of monomer A-BPEF (9,9-Bis[4-(2-acryloyloxyethoxy)phenyl]fluorene), 55.3% by weight of monomer SR368 (tris-(2-hydroxethyll)-isocyanurate triacrylate) available from Sartomer and 3.1% by weight of SR423D (isobornyl methacrylate), a monomer available from Sartomer, and 0.6% by weight of photo-initiator Irgacure® 184 made by Ciba.

The resin was previously dissolved in methylene chloride and the solvent removed by evaporation before impregnation. A second PET sheet was laid over the impregnated samples and the resulting multilayer product was laminated at 100° C.

The resulting laminate was exposed to UV radiation, with a dose of 0.9 J/cm², supported between two glass sheets. The glass and PET sheets were removed and the composite film was heated for 30 minutes at 250° C. under nitrogen.

After cooling to room temperature, a transparent composite film was obtained having a total thickness of 80 μm and a content in glass fibers of 48.7% by weight.

### Comparative Example 2

Example of preparation of the composite film using a single known monomer, not described in the present invention.

The procedure of comparative example 1 was replicated using only SR368, a monomer having a low refractive index, as the only monomer in resin B.

After cooling to room temperature, a hazy composite film was obtained having a total thickness of 79 μm and content in glass fibers of 50.1% by weight.

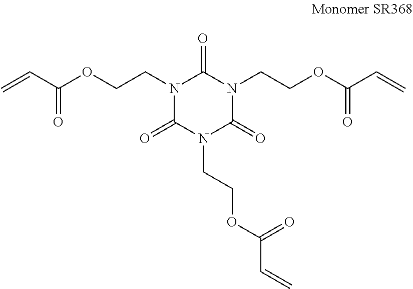 [SMILES: C=CC(=O)OCCn1c(=O)n(CCOC(=O)C=C)c(=O)n(CCOC(=O)C=C)c1=O]

### Comparative Example 3

Example of preparation of the composite film using a single known monomer not described in the present invention. The procedure in comparative example 1 was replicated using SR349 (bisphenol A Ethoxylate 3 diacrylate) only, a monomer available from Sartomer, with a refractive index equal to the glass fiber, in composition B.

After cooling to room temperature, a transparent composite film was obtained having a total thickness of 80 μm and content in glass fibers of 49% by weight.

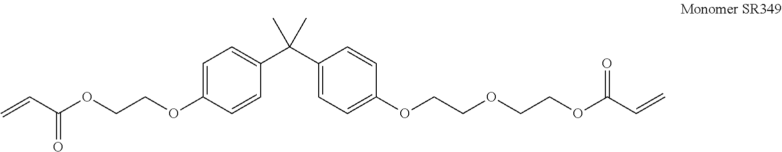 [SMILES: C=CC(=O)OCCOCCOc1ccc(C(C)(C)c2ccc(OCCOC(=O)C=C)cc2)cc1]

### Comparative Example 4

Example of preparation of a composite film using a single known monomer not described in the present invention. The procedure to comparative example 1 was replicated using the monomer A-BPEF (9,9-Bis[4-(2-acryloyloxyethoxy)phenyl]fluorene) only, a monomer having an index of refraction higher than glass fibers, in composition.

After cooling to room temperature a composite film was obtained having a total thickness of 80 μm end a content in glass fibers of 48% by weight.

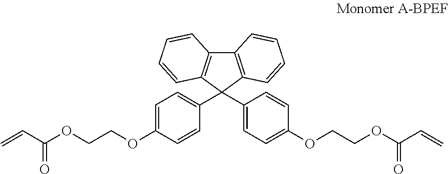 [SMILES: C=CC(=O)OCCOc1ccc(C2(c3ccc(OCCOC(=O)C=C)cc3)c3ccccc3-c3ccccc32)cc1]

### Example 6

Characterization of the Composite Film Described in the Present Invention

Transparency

The transparency to optical radiation of a sample of the composite film prepared according to the present invention is measured by a spectrophotometer Perkin-Elmer UV/VIS lambda 12 with monoray integration sphere RSA-PE-20, controlled by a P.C. IBM 330-100DX4 with software Perkin Elmer PECSS version 4.31. The instrument is used with a suitable setting (Region X, scan speed=240 nm/minute, smooth bandwidth 2 nm, interval 1 nm, ordinate mode T) and preliminarily calibrated in air without sample. The readout scale (suitably variable from 300 to 800 nm) is reduced to 400-800 nm corresponding to the radiation range visible by human eye. The average transmittance is computed as the average value of transmittance obtained by the sum of measured values divided by the number of measures.

If the average transmittance is higher than 80%, thus satisfying the transparency requirement a triangle Δ is given, if the average transmittance is from 75% to 80% a square □ is given, if the average Transmittance is lower than 75% a cross X is given.

Resistance to Heat

The thermal resistance of a sample of the composite film according to the present invention is determined by dynamic-mechanical analysis (DMA) by a Perkin-Elmer 7 analyzer, working in viscoelastic oscillation with a frequency of 1 Hz. The glass transition temperature (Tg) was measured at the onset of the storage modulus plot in a temperature scan. The peak value of the tanDelta curve, expressed in ° C. was also measured.

Coefficient of Linear Thermal Expansion

The coefficient of linear thermal expansion (CTE) is measured by thermo-mechanical analysis using a Perkin-Elmer DMA 7 analyzer in TMA mode in extension, equipped by furnace and accessory for film measurement.

The sample is mounted in a quartz probe for extension measures and heated initially to 150° C. with a heating rate of 10° C./min, and held at 150° C. for 10 to remove residual volatiles and moisture. The sample is then cooled to 30° C. and held at 30° C. for 10 minutes. The sample is then heated again from 30° C. to 150° C., with a heating rate of 2° C./min.

The analyzer reads the extension of the sample during the temperature scan. The value of the coefficient of linear thermal expansion (CTE) is computed according to the following expression:

CTE=DL/L₃₀/120° C.

Where DL/L₃₀ is the measure in parts per million (ppm) of the extension of the sample from the initial temperature (30° C.) through the final temperature (150° C.) compared to its initial length at 30° C., measured during the final temperature scan.

The results are reported in the following Table 1

TABLE 1

| | | Examples | | | Comparative Examples | | | |
|---|---|---|---|---|---|---|---|---|
| Monomers | | 3 | 4 | 5 | 1 | 2 | 3 | 4 |
| High | B1a | 34.15% | | | | | | |
| Refractive | B1b | | 33.80% | | | | | |
| Monomer | B1c | | | 22.40% | | | | |
| | A-BPEF | | | | 41.00% | | | 99.50% |
| | SR349 | | | | | | 99.50% | |
| Low | B2a | 63.41% | 62.80% | 75.10% | | | | |
| Refractive | SR368 | | | | 55.30% | 98.60% | | |
| Monomer | SR423D | | | | 3.10% | | | |
| Curing | Luperox | 2.44% | 3.40% | 2.5% | | | | |
| Initiator | P | | | | 0.6% | 1.40% | 0.50% | 0.50% |
| | Irgacure | | | | | | | |
| | 184 | | | | | | | |
| Glass | Unitika | 4 | 4 | 4 | 4 | 4 | 4 | 4 |
| clothes | Cloth | | | | | | | |
| number | E02Z | | | | | | | |
| | (15 μ) | | | | | | | |

| | | | | | | | |
|---|---|---|---|---|---|---|---|
| Glass clothes % | 58% | 55.04% | 55.00% | 48.70% | 50.1% | 49% | 48% |
| in final material | | | | | | | |
| Transparency | Δ | Δ | Δ | Δ | X | Δ | X |
| Peak of | >400 | >400 | >400 | 265 | 275 | 77 | 260 |
| Tan Delta | | | | | | | |
| onset | 450 | 380 | 420 | 210 | 230 | 40 | 220 |
| Tg (° C.) | | | | | | | |
| CTE (ppm/° C.) | 12 | 15 | 14 | 20 | 18 | 19 | 21 |

1. A composite film comprising a substrate (A) of inorganic fibers impregnated by a resin, where said resin is obtained by the polymerization of a composition (B) comprising:
a first monomer (B1) having an index of refraction higher than said inorganic fibers, said first monomer (B1) being selected from the group consisting of (i) esters of 9,9′-bis(4-hydroxyphenyl)fluorene or its ethoxylated derivate with cinnamic acid or its derivates or crotonic acid or its derivates, (ii) mixed esters of 9,9′-bis(4-hydroxyphenyl)fluorene or its ethoxylated derivate with cinnamic acid or its derivates and acrylic or methacrylic acid, (iii) mixed esters of 9,9′-bis(4-hydroxyphenyl)fluorene or its ethoxylated derivate with crotonic acid and acrylic or methacrylic acid, (iv) ethers of 9,9′-bis(4-hydroxyphenyl)fluorene or its ethoxylated derivate with allylic alcohol and (v) monoesters of 9,9′-bis(4-hydroxyphenyl)fluorene monoallylether or its ethoxylated derivate with cinnamic acid or its derivates, or crotonic acid or its derivates, or acrylic or methacrylic acid; and
a second monomer (B2) having an index of refraction lower than the inorganic fibers, said second monomer (B2) consisting of a triazinetrione derivate having at least one polymerizable substituted group.

2. A composite film according to claim 1, where said composition (B) further comprises a filler (C) made of functionalized inorganic particles, wherein the nominal size of said particles is smaller than 0.001 mm in diameter.

3. A composite film according to claim 1, where said inorganic fibers are selected from the group consisting of glass fibers and/or ceramic fibers.

4. A composite film according to claim 1, where said first monomer (B1) is represented by the following generic formulae (B1-i) or (B1-ii): 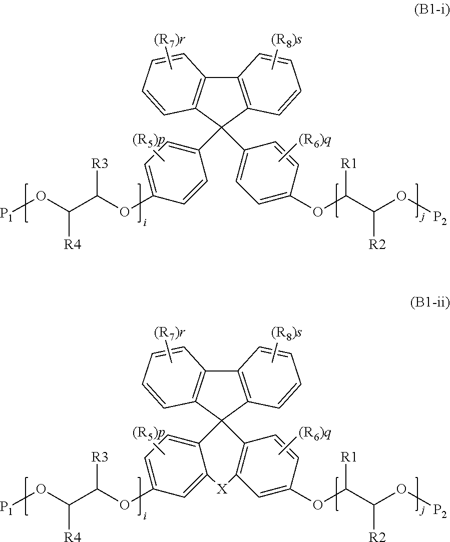
where
R₁, R₂, R₃ and R₄, equal or different, each independently is a hydrogen atom or an alkyl group having 1 to 3 carbons,
i and j are integer numbers, from 0 to 4, whose sum is equal to or lower than 4;
R₅, R₆, R₇, and R₈, equal or different, each independently is a hydrogen atom; a halogen atom; an alkyl group with 1 to 6 carbons; a cycloalkyl group with 3 to 6 carbons; an alkoxy group with 1 to 6 carbons; an aryloxy group with 6 to 12 carbons; a haloalkyl group —CₙY_{z}H_{(2n+1-z)} where Y is selected from the group consisting of fluorine, chlorine, bromine and iodine, n is an integer from 1 to 12 and z is an integer from 1 to (2n+1); a carbonyl group —COR, an ester group —OCOR or —COOR where is an alkyl group having 1 to 6 carbons;
p, q, r, s, are integer numbers from 0 to 4 in formula (B1-i);
p, q, are integer numbers from 0 to 4 and r, s are integer numbers from 0 to 3 in formula (B1-ii);
X is a divalent radical selected from the group consisting of O, S, or a —CR₁₀R₁₁ alkylidene group, wherein R₁₀ and R₁₁, equal or different, each independently is a hydrogen atom or an alkyl group having 1 to 3 carbons;
P₁ and P₂, equal or different, each independently is a polymerizable group comprising a double bond selected from the group consisting of: 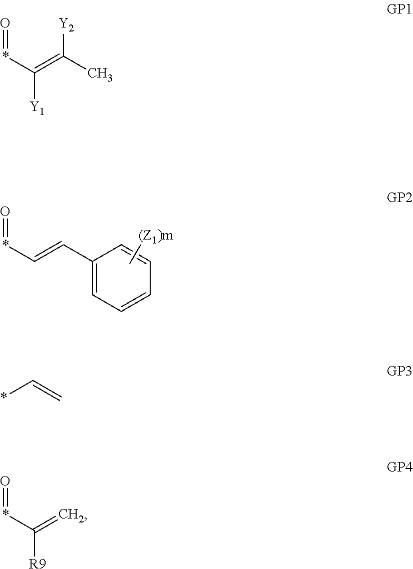
wherein,
* represents the carbon bound to the oxygen
Y₁ and Y₂, equal or different, each independently is a hydrogen atom or an alkyl group having 1 to 3 carbons;
Z₁ is a hydrogen atom; a halogen atom; an alkyl group having 1 to 6 carbons; a cycloalkyl group having 3 to 6 carbons; an alkoxy group having 1 to 6 carbons; an aryloxy group having 6 to 12 carbons; a halolkyl group —CₙY_{z}H_{(2n+1-z)} where Y is selected from the group consisting of fluorine, chlorine, bromine and iodine, n is an integer from 1 to 12 and z is an integer from 1 to (2n+1); a carbonyl group —COR, an ester group —OCOR or —COOR, where R is an alkyl group having 1 to 6 carbons; and m is an integer from 0 to 5; and
R9 is a hydrogen atom or a methyl group;
with the proviso that at least one of P₁ and P₂ is different than GP4 group.

5. A composite film according to claim 4, where said first monomer (B1) is represented by the generic formulae herein below: 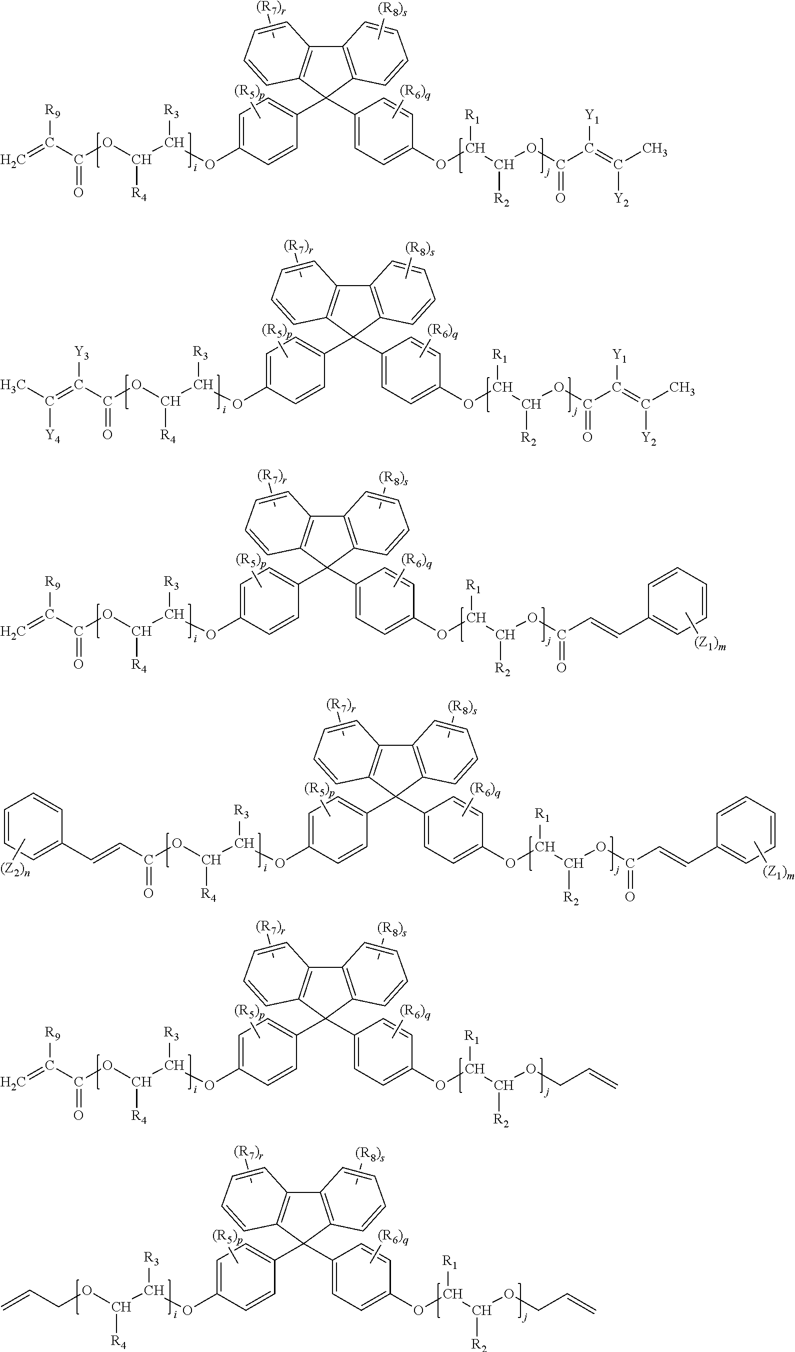 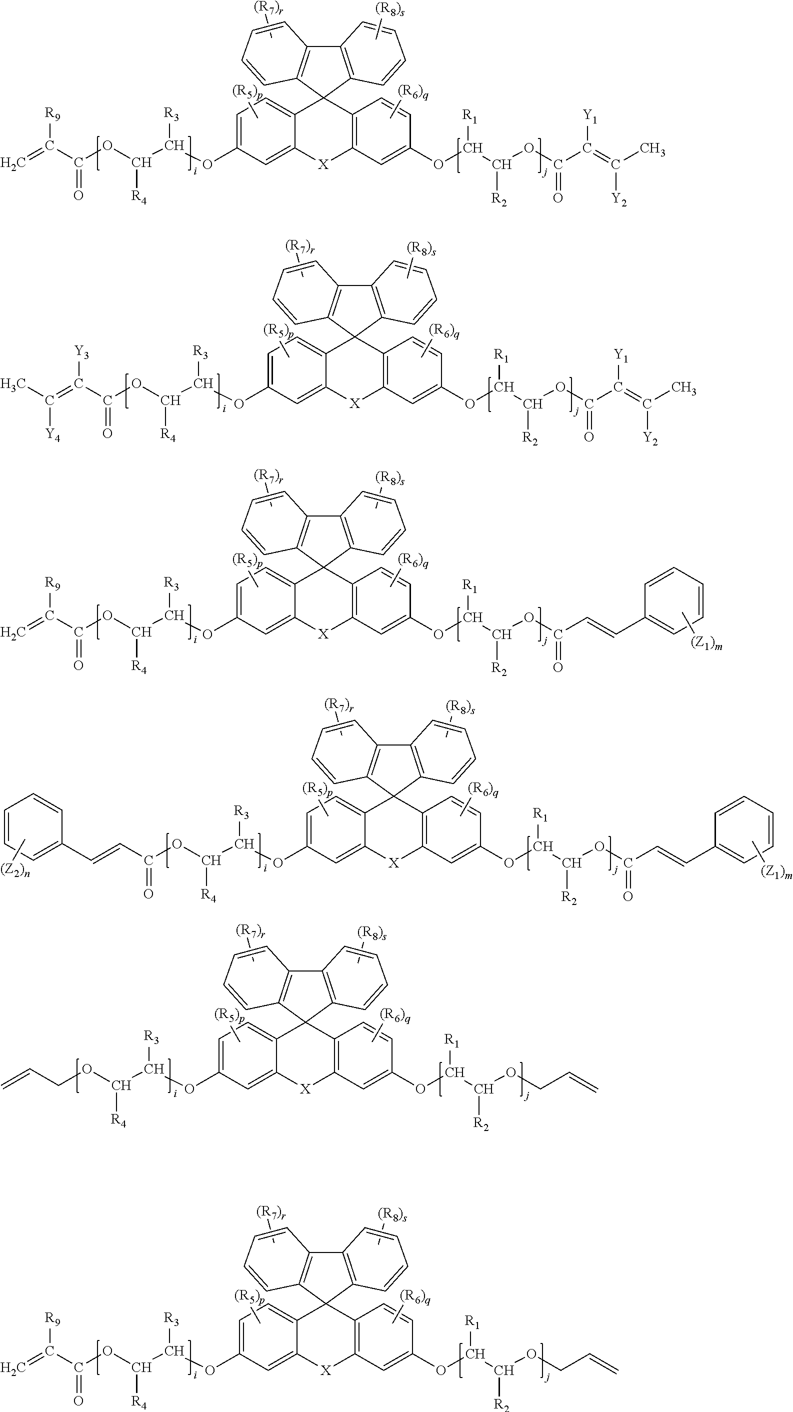
where
R₁, R₂, R₃ R₄, R₅, R₆, R₇, R₈, R₉, X, have the meaning defined in claim 4;
i, j, p, q, r, s, are integer numbers as described in claim 4;
Y₁, Y₂, Y₃ and Y₄, equal or different, each independently is a hydrogen atom or an alkyl group having 1 to 3 carbons;
Z₁ and Z₂, equal or different, each independently is a hydrogen atom; a halogen atom; an alkyl group having 1 to 6 carbons; a cycloalkyl group having 3 to 6 carbons; an alkoxy group having 1 to 6 carbons; an aryloxy group having 6 to 12 carbons; a haloalkyl group —CₙY_{z}H_{(2n+1-z)} where Y is selected from the group consisting of fluorine, chlorine, bromine and iodine, n is an integer from 1 to 12 and z is an integer from 1 to (2n+1); a carbonyl group —COR, an ester group —OCOR or —COOR, where R is an alkyl group having 1 to 6 carbons; and m is an integer from 0 to 5.

6. A composite film according to claim 1, where said monomer (B2) is represented by the following generic formula: 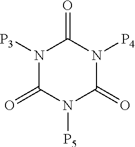
where P₃, P₄, and P₅, equal or different, are polymerizable groups comprising a double bond or non-polymerizable groups,
with the proviso that at least one of P₃, P₄, and P₅ is a polymerizable group comprising a double bond.

7. A composite film according to claim 6 where said non-polymerizable group is selected from the group consisting of an alkyl group having 1 to 6 carbons; a cycloalkyl group having 3 to 6 carbons; a cycloalkyl group —CₙY_{z}H_{(2n+1-z)} where Y is fluorine, chlorine, bromine or iodine, n is an integer from 1 to 12, and z is an integer from 1 to (2n+1); an alkyl group having 1 to 6 carbons substituted by a nitrile group (—CN), carbonyl (—COR), or ester (—OCOR or —COOR where R is an alkyl group having 1 to 6 carbons); a polyalkylenoxy group —((CH2)w-O)x-H, where w and x, are independently integer numbers from 1 to.

8. A composite film according to claim 6 where said polymerizable group is selected from the group consisting of allyl group, allylether group, vinylether group or a derivate thereof, ester of the cinnamic acid or a derivate thereof, ester of the crotonic acid or a derivate thereof, ester of the 3-alkoxy-propanoic acid or a derivate.

9. A composite film according to claim 1, where said composition (B) comprises a reactive thinner.

10. A composite film according to claim 9 where said reactive thinner is selected from the group consisting of acrylates and methacrylates having viscosity lower than 1 Pa·s.

11. A composite film according to claim 2, where said functionalized inorganic particles are made of silica, alumina and mixtures thereof.

12. A resin obtained by the polymerization of a composition (B) comprising:
a first monomer (B1) selected from the group consisting of (i) esters of 9,9′-bis(4-hydroxyphenyl)fluorene or its ethoxylated derivate with cinnamic acid or its derivates or crotonic acid or its derivates, (ii) mixed esters of 9,9′-bis(4-hydroxyphenyl)fluorene or its ethoxylated derivate with cinnamic acid or its derivates and acrylic or methacrylic acid, (iii) mixed esters of 9,9′-bis(4-hydroxyphenyl)fluorene or its ethoxylated derivate with crotonic acid and acrylic or methacrylic acid, (iv) ethers of 9,9′-bis(4-hydroxyphenyl)fluorene or its ethoxylated derivate with allylic alcohol and (v) monoesters of 9,9′-bis(4-hydroxyphenyl)fluorene monoallylether or its ethoxylated derivate with cinnamic acid or its derivates, or crotonic acid or its derivates, or acrylic or methacrylic acid; and
a second monomer (B2) consisting of a triazinetrione derivate having at least one polymerizable substituted group.

13. A resin according to claim 12, where said composition (B) further comprises a filler (C) made of functionalized inorganic particles, wherein the nominal size of said particles is smaller than 0.001 mm in diameter.

14. A resin according to claim 12, where such resin has an onset Tg higher than or equal to 250° C.

15. A resin according to claim 12 where the average transparency of said resin, in a range of wavelengths from 300 to 700 nm, is higher than or equal to 80%.

16. A composite film comprising a substrate (A) made of inorganic fibers impregnated by a resin, where said resin is obtained by polymerization of the composition (B) according to claim 12, and where said composite film has an average transparency, in a range of wavelengths from 300 to 700 nm, higher than or equal to 80%.

17. A composite film comprising a substrate (A) made of inorganic fibers impregnated by a resin, where said resin is obtained by the polymerization of a composition (B) according to claim 12, where said composite film has an onset Tg higher than or equal to 250° C.

18. A composite film comprising a substrate (A) made of inorganic fibers impregnated by a resin, where said resin is obtained by the polymerization of a composition (B) according to claim 12, said composite film having a coefficient of linear thermal expansion lower than or equal to 20 ppm/° C.

19. A cured resin having an average transparency, measured in the range from 400 to 700 nm, higher than or equal to 80% and an onset Tg higher than or equal to 280° C.

20. The cured resin of claim 19, said resin having a peak of Tan Delta curve at a temperature higher than or equal to 325° C.
